(19) United States
(12) Patent Application Publication
(10) Pub. No.: US 2024/0104236 A1
(43) Pub. Date: Mar. 28, 2024

(54) SAFE CONTENT DISCOVERY

(71) Applicant: Meta Platforms, Inc., Menlo Park, CA (US)

(72) Inventors: Robin Dsouza, New York, NY (US); Kayla Marie Schulz, New York, NY (US); Yi Liu, Guttenberg, NJ (US); Kripashankar Mohan, San Jose, CA (US); Ashish Upadhyay, Santa Clara, CA (US)

(21) Appl. No.: 18/087,511

(22) Filed: Dec. 22, 2022

Related U.S. Application Data
(60) Provisional application No. 63/410,669, filed on Sep. 28, 2022.

(51) Int. Cl. G06F 21/62; G06F 21/31

(52) U.S. Cl. CPC G06F 21/6218; G06F 21/31; G06F 2221/2141; G06Q 50/01

(57) ABSTRACT

A method may include determining an threshold user tolerance level associated with one or more sensitive content classifications. The method may include receiving a request to generate a first user account. The method may include receiving one or more instances of first user account data, wherein the one or more instances of first user account data include at least an indication of the first user's age. The method may include generating, based at least in part on the one or more instances of first user account data, the first user account. The method may include configuring, based at least in part on determining that the first user's age fails to satisfy a sensitive content age threshold, one or more first user account settings to restrict sensitive content at or above the threshold user tolerance level.

### CROSS-REFERENCE TO RELATED APPLICATION

The present application claims the benefit of priority to U.S. Application No. 63/410,669 entitled “Safe Content Discovery,” filed Sep. 28, 2022, the content of which is incorporated herein by reference in its entirety.

### BACKGROUND

Social networking platforms provide users with many benefits. For example, social networking platforms provide users with opportunities to interact with and share information and content with other users all over the world, in ways that are not possible in the brick and mortar world. Many social networks provide users with the ability to search for other users to follow and/or content to view that is of interest to them. In some examples, social networks may also suggest or recommend certain content to view and/or certain users to follow or connect with that may be of interest to the users. Utilizing a standardized search and/or discovery model within a social networking platform may lead to consumption of content that is not age-appropriate for younger users (e.g., teenagers). Nonetheless, it is desirable to provide all users of a social networking system with some autonomy to regulate the content they consume and are presented.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a view of an example system usable to assist with presenting users with age-appropriate content, according to some implementations.

FIG. 2 is an example system and device that is usable to implement the techniques described herein, according to some implementations.

FIG. 3 is an example interface illustrating various modes for setting sensitivity settings, according to some implementations.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

As discussed above, using standardized search and/or discovery models within a social networking platform may lead to consumption of content that is not age-appropriate for some users, particularly younger users (e.g., teenagers). What is safe and age-appropriate for users of a first age (e.g., adults) may be different than what is safe and age-appropriate for users of different ages (e.g., teens). Some existing search models allow users to explicitly set sensitivity settings indicating their tolerance to sensitive content (e.g., violence, profanity, nudity, etc.). However, traditional solutions do not allow for different sensitivity settings for users of differing ages (e.g., adults, teens, etc.). This application describes a search and discovery system that may be implemented to present age-appropriate content for users (e.g., teen users). In some examples, the system may be implemented for searches, friend suggestions, in feed recommendations, comments, hashtag pages, autocomplete results, and/or other content that the user can interact with via the social networking platform. Any or all of these sources/types of content can be filtered to show content that is safe and age-appropriate for the user.

Much of the information and imagery consumed by teenagers is presented via social media. For example, teenagers often manage and/or monitor several social media accounts dedicated to various aspects of their lives. Moreover, the teenage years are an important developmental stage, wherein younger social media users are particularly susceptible to the content they consume. However, traditional search and discovery mechanisms within social networking systems are inadequate to protect younger users from consuming sensitive content and/or content that is not age-appropriate. Methods and systems of the present disclosure may overcome these deficiencies. For example, embodiments of the present disclosure may include a safe content discovery protocol that is configured to minimize the likelihood that younger users are exposed to sensitive social media content. A safe content discovery protocol may restrict from presentation to younger users any content that exceeds a threshold user tolerance level. The safe content discovery protocol may be implemented within a variety of interaction surfaces throughout the social networking system, including but not limited to explore pages, reels, searches, friend suggestions, in-feed recommendations, comments, hashtag pages with which a user can interact, and autocomplete results.

A social networking system may determine various sensitive content classifications. For example, any social media content characterized by full or partial nudity, violence, sexuality, and/or obscenity (e.g., profanity and/or other vulgarity) may be considered within the social networking system to be “sensitive content.” Content may be determined to contain sensitive content if it is classified as containing one or a combination of these different types of sensitive content. Thus, the social networking system may be configured to limit and/or restrict presentation of such content. In some examples, limiting and/or restricting presentation of sensitive content may include limiting suggested posts and/or accounts containing the sensitive content, excluding posts and/or accounts containing the sensitive content from search results and the like.

In order to facilitate the safe content discovery protocol described herein, a social networking system may be able to determine the likelihood that an “average user” will find social media content acceptable. As used herein, the phrase “average user” may describe a normalized statistical characterization of various user demographics (e.g., age, social media usage data, etc.) associated with the social networking system that is used to predict a particular outcome. In other words, the social networking system may be able to statistically predict the likelihood that a given instance of social media content will be deemed appropriate (or, conversely inappropriate) by most users of the social networking system for a given age or age range. Thus, the social networking system may be able to determine a threshold user tolerance level that quantifies the likelihood that any given social media content will be inappropriate for consumption by users of a given age.

In some cases, the social networking system of various embodiments is configured to establish, for a given interaction surface, a threshold user tolerance level of at or near 50%, such that social media content that is more likely (i.e., above a 50% chance) to be deemed inappropriate is restricted from presentation. In some cases, the threshold user tolerance level of 50% may be a default user account setting associated with all user accounts (for a given interaction surface.) In some other cases, the threshold user tolerance level of 50% may be a default user account setting associated with accounts wherein the user is below an age threshold (e.g., 15, 16, 17, or any appropriate age). In still some other cases, the social networking system of various embodiments is further configured to establish, for a given interaction surface, higher or lower threshold user tolerance levels. For example, the social networking system may be configured to establish an threshold user tolerance level of at or near 25%, signifying that an instance of social media content is more than likely (i.e., a 75% chance) to be deemed inappropriate. Accordingly, the social networking system of such examples may be configured, by default, to restrict instances of sensitive social media content from presentation until one or more user account settings are changed. In some examples, the social networking system of various embodiments can be configured so that an option to allow more sensitive content is disabled or otherwise unavailable to users below a threshold age (e.g., teens or youth). In other words, younger users of a social networking system implementing methods described herein may be restricted from changing their user account settings to allow content that is more likely to be inappropriate for their age. However, it is also contemplated that the social networking system of various embodiments may be configured to allow users the option to be presented with less sensitive content. For example, the social networking system of various embodiments may be configured to determine an threshold user tolerance level of at or near 75%, signifying that an instance of social media content is less than likely (i.e., a 25% chance) to be deemed inappropriate.

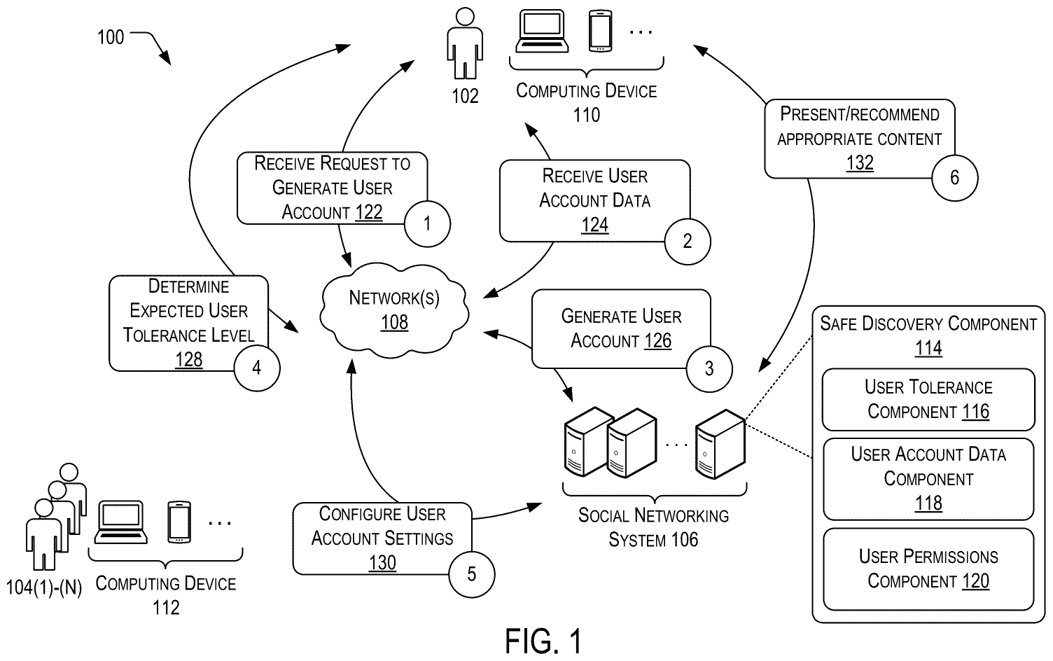

The following will provide, with reference to FIGS. 1, 2, and 3, detailed descriptions of methods and systems for safer content discovery within a social networking system.

FIG. 1 is a view of an example system 100 usable to limit exposure of younger users (e.g., teens) from exposure to sensitive content according to some implementations. In some examples, the system 100 may include a user 102 who may be a youth (i.e., teenage) account creator, as well as other users 104(1)-104(N) (collectively “users 104”). The system 100 may be used to determine an threshold user tolerance level for the user 102 and/or the other users 104. The user 102 and the other users 104 may interact with a social networking system 106 via a network 108 using computing devices, generally indicated by 110 and 112, respectively.

In the illustrated example, the social networking system 106 may include a safe discovery component 114. The safe discovery component 114 may include a number of sub-components or modules, such as user tolerance component 116, user account data component 118, and user permissions component 120. The user tolerance component 116 may be configured to analyze social media content (i.e., posts, messages, searches, etc.) to determine a statistical likelihood that an instance of social media content is inappropriate. The user account data component 118 may be configured to receive and/or authenticate or verify one or more instances of user account data. The user account data component 118 may be configured to authenticate or otherwise verify user account data using any appropriate authentication scheme, including multi-factor authentication, biometrics, and the like. The user permissions component 120 may be configured to provide functionality to search or otherwise discover content of an acceptable or appropriate tolerance level in response to the user 102 or users 104 setting a user account preference.

With respect to FIG. 1, the user 102 may be a teenaged social networking user. For instance, in the illustrated example, the user 102 may, at operation 122 (indicated by the numeral “1”), request to create a new user account.

In the illustrate example, at operation 124, (indicated by the numeral “2”), the social networking system 106 (i.e., the user account data component 118) may receive one or more instances of user account data. In some examples, the one or more instances of user account data may include at least an indication of the age of the user 102.

In the illustrated example, at operation 126, (indicated by the numeral “3”), the social networking system 106 may generate and/or publish the user account.

Next, at operation 128 (indicated by the numeral “4”), the social networking system 106 (i.e., the user tolerance component 116) may determine a threshold user tolerance level for users of the same age or age range as the user 102. For example, the users 104 may share content, some of which may not be age-appropriate for the user 102. Therefore, in some cases the social networking system 106 may not recommend certain of the users 104 as connections for user the 102, because of the age-inappropriateness of the content they share. In some cases, the social networking system may implement a machine learning algorithm trained to predict a threshold user tolerance level. For example, a machine learning algorithm may be trained to detect sound events in an audio signal, and combine or aggregate the classifications of individual sound events. In some examples, a machine learning algorithm may also classify video content, such as, based on multiple dimensions (e.g., x- and y-dimensions) present in individual frames. In this way, a machine learning algorithm may be trained to determine what is “happening” in social networking content (i.e., to determine whether the content is characterized by one or more sensitive content classifications). The social networking system 106 (i.e., the user tolerance component 116) may then, based on the determination that content is characterized by one or more sensitive content classifications, determine a threshold user tolerance level.

At operation 130 (indicated by the numeral “5”), the social networking system 106 (i.e., the user permissions component 120) may configure one or more user account settings based on the user account data. For example, if the user 102 is under a threshold age (e.g., 14 years old, 16 years old, 17 years old, 18 years old, etc.), then the social networking system 106 may configure one or more user account settings to filter, by default, social networking content at or above the threshold user tolerance.

At operation 132 (indicated by the numeral “6”), the social networking system 106 (e.g., the safe discovery component 114 or one or more sub-components thereof) may present and/or recommend appropriate content to the user 102. The social networking system 106 may present and/or recommend such appropriate content based on age, user permission settings, etc. For example, if the user 102 is under a threshold age, then the social networking system 106 may not present or recommend content that is determined (i.e., based on the determination at operation 128) to be age-inappropriate. In certain cases, presenting and/or recommending appropriate content may include providing a warning that certain content may be sensitive. In at least some such cases, the user 102, being under a threshold age, may not be permitted to click through such warning(s) to proceed to the content. Put another way, in some examples the user 102 may receive a warning explaining that the user 102 does not have permission to view the sensitive content.

In the illustrated example, each of the computing devices 110 and 112 may include one or more processors and memory storing computer executable instructions to implement the functionality discussed herein attributable to the various computing devices. In some examples, the computing devices 110 and 112 may include desktop computers, laptop computers, tablet computers, mobile devices (e.g., smart phones or other cellular or mobile phones, mobile gaming devices, portable media devices, etc.), or other suitable computing devices. The computing devices 110 and 112 may execute one or more client applications, such as a web browser (e.g., Microsoft Windows Internet Explorer, Mozilla Firefox, Apple Safari, Google Chrome, Opera, etc.) or a native or special-purpose client application (e.g., social media applications, messaging applications, email applications, games, etc.), to access and view content over the network 108.

The network 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the computing devices 110 and 112 may access the social networking system 106 and/or communicate with one another.

The social networking system 106 may include one or more servers or other computing devices, any or all of which may include one or more processors and memory storing computer executable instructions to implement the functionality discussed herein attributable to the social networking system or digital platform. The social networking system 106 may enable the user 102 and users 104 (such as persons or organizations) to interact with the social networking system 106 and with each other via the computing devices 110 and 112. The social networking system 106 may, with input from a user, create and store in the social networking system 106 a user account associated with the user. The user account may include demographic information, communication-channel information, and information on personal interests of the user. The social networking system 106 may also, with input from a user, create and store a record of relationships of the user with other users of the social networking system 106, as well as provide services (e.g., posts, comments, photo-sharing, messaging, tagging, mentioning of other users or entities, games, etc.) to facilitate social interaction between or among the users.

In some examples, the social networking system 106 may provide privacy features to the users 102 and 104 while interacting with the social networking system 106. In particular examples, one or more objects (e.g., content or other types of objects) of the system 106 may be associated with one or more privacy settings. The one or more objects may be stored on or otherwise associated with any suitable computing system or application, such as, for example, the social networking system 106, a client system, a third-party system, a social networking application, a messaging application, a photo-sharing application, or any other suitable computing system or application. Although the examples discussed herein are in the context of an online social network, these privacy settings may be applied to any other suitable computing system. Privacy settings (or “access settings”) for an object or item of content may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example, and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” and/or a “restricted list” of users or other entities that should not be allowed to access certain information associated with the object. In particular examples, the blocked list may include third-party entities. The blocked list or restricted list may specify one or more users or entities for which an object is not visible. As an example, and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example, and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular examples, privacy settings may be based on one or more nodes or edges of a social graph. A privacy setting may be specified for one or more edges or edge-types of the social graph, or with respect to one or more nodes or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example, and not by way of limitation, a user, such as a user 102 and 104, may share an object to the social networking system 106. The object may be associated with a concept node connected to a user node of the user 102 and/or 104 by an edge. The user 102 and/or 104 may specify privacy settings that apply to a particular edge connecting to the concept node of the object or may specify privacy settings that apply to all edges connecting to the concept node. In some examples, the user 102 and/or 104 may share a set of objects of a particular object-type (e.g., a set of images). The user 102 and/or 104 may specify privacy settings with respect to all objects associated with the user 102 and/or 104 of that particular object-type as having a particular privacy setting (e.g., specifying that all images posted by the user 102 and/or 104 are visible only to friends of the user and/or users tagged in the images).

In particular examples, the social networking system 106 may present a “privacy wizard” (e.g., within a webpage, a module, one or more dialog boxes, or any other suitable interface) to the user 102 and/or 104 to assist the user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the social networking system 106 may offer a “dashboard” functionality to the user 102 and/or 104 that may display, to the user 102 and/or 104, current privacy settings of the user 102 and/or 104. The dashboard functionality may be displayed to the user 102 and/or 104 at any appropriate time (e.g., following an input from the user 102 and/or 104 summoning the dashboard functionality, following the occurrence of a particular event or trigger action). The dashboard functionality may allow the user 102 and/or 104 to modify one or more of the user's current privacy settings at any time, in any suitable manner (e.g., redirecting the user 102 and/or 104 to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, one or more servers of the social networking system 106 may be authorization/privacy servers for enforcing privacy settings. In response to a request from the user 102 and/or 104 (or other entity) for a particular object stored in a data store, the social networking system 106 may send a request to the data store for the object. The request may identify the user 102 and/or 104 associated with the request and the object may be sent only to the user 102 and/or 104 (or a client system of the user) if the authorization server determines that the user 102 is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular examples, an object may represent content that is visible to a user through a newsfeed of the user. As an example, and not by way of limitation, one or more objects may be visible to a user's “Trending” page. In particular examples, an object may correspond to a particular user. The object may be content associated with the particular user, or may be the particular user's account or information stored on the social networking system 106, or other computing systems. As an example, and not by way of limitation, the user 102 and/or 104 may view one or more other users 102 and/or 104 of an online social network through a “People You May Know” function of the online social network, or by viewing a list of friends of the user 102. As an example, and not by way of limitation, the user 102 and/or 104 may specify that they do not wish to see objects associated with a particular other user (e.g., the user 102 and/or 104) in their newsfeed or friends list. If the privacy settings for the object do not allow it to be surfaced to, discovered by, or visible to the user 102 and/or 104, the object may be excluded from the search results. Although this disclosure describes enforcing privacy settings in a particular manner, this disclosure contemplates enforcing privacy settings in any suitable manner.

In particular examples, different objects of the same type associated with a user may have different privacy settings. Different types of objects associated with a user may also have different types of privacy settings. As an example, and not by way of limitation, the user 102 and/or 104 may specify that the user's status updates are public, but any images shared by the user are visible only to the user's friends on the online social network. In some examples, the user 102 and/or 104 may specify different privacy settings for different types of entities, such as individual users, friends-of-friends, followers, user groups, or corporate entities. In some examples, the user 102 and/or 104 may specify a group of users that may view videos posted by the user 102 and/or 104, while keeping the videos from being visible to the user's employer. In particular examples, different privacy settings may be provided for different user groups or user demographics. As an example, and not by way of limitation, the user 102 and/or 104 may specify that other users who attend the same university as the user 102 and/or 104 may view the user's pictures, but that other users who are family members of the user 102 and/or 104 may not view those same pictures.

In particular examples, the social networking system 106 may provide one or more default privacy settings for each object of a particular object-type. A privacy setting for an object that is set to a default may be changed by a user associated with that object. As an example, and not by way of limitation, all images posted by the user 102 and/or 104 may have a default privacy setting of being visible only to friends of the first user and, for a particular image, the user 102 and/or 104 may change the privacy setting for the image to be visible to friends and friends-of-friends.

In particular examples, privacy settings may allow the user 102 and/or 104 to specify (e.g., by opting out, by not opting in) whether the social networking system 106 may receive, collect, log, or store particular objects or information associated with the user 102 and/or 104 for any purpose. In particular examples, privacy settings may allow the user 102 and/or 104 to specify whether particular applications or processes may access, store, or use particular objects or information associated with the user. The privacy settings may allow the user 102 and/or 104 to opt in or opt out of having objects or information accessed, stored, or used by specific applications or processes. The social networking system 106 may access such information in order to provide a particular function or service to the user 102 and/or 104, without the social networking system 106 having access to that information for any other purposes. Before accessing, storing, or using such objects or information, the social networking system 106 may prompt the user 102 and/or 104 to provide privacy settings specifying which applications or processes, if any, may access, store, or use the object or information prior to allowing any such action. As an example, and not by way of limitation, the user 102 and/or 104 may transmit a message to the user 102 and/or 104 via an application related to the online social network (e.g., a messaging app), and may specify privacy settings that such messages should not be stored by the social networking system 106.

In particular examples, the user 102 and/or 104 may specify whether particular types of objects or information associated with the user 102 and/or 104 may be accessed, stored, or used by the social networking system 106. As an example, and not by way of limitation, the user 102 and/or 104 may specify that images sent by the user 102 and/or 104 through the social networking system 106 may not be stored by the social networking system 106. In some examples, the user 102 and/or 104 may specify that messages sent from the user 102 and/or 104 to another user may not be stored by the social networking system 106. In some cases, the user 102 and/or 104 may specify that all objects sent via a particular application may be saved by the social networking system 106.

In particular examples, privacy settings may allow the user 102 and/or 104 to specify whether particular objects or information associated with the user 102 and/or 104 may be accessed from particular client systems or third-party systems. The privacy settings may allow the user 102 and/or 104 to opt in or opt out of having objects or information accessed from a particular device (e.g., the phone book on a user's smart phone), from a particular application (e.g., a messaging app), or from a particular system (e.g., an email server). The social networking system 106 may provide default privacy settings with respect to each device, system, or application, and/or the user 102 and/or 104 may be prompted to specify a particular privacy setting for each context. As an example, and not by way of limitation, the user 102 and/or 104 may utilize a location-services feature of the social networking system 106 to provide recommendations for restaurants or other places in proximity to the user 102 and/or 104. The default privacy settings of the user 102 and/or 104 may specify that the social networking system 106 may use location information provided from the computing device 110 and/or 112 of the user 102 and/or 104 to provide the location-based services, but that the social networking system 106 may not store the location information of the user 102 and/or 104 or provide it to any third-party systems. The user 102 and/or 104 may then update the privacy settings to allow location information to be used by a third-party image-sharing application in order to geo-tag photos.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example, and not by way of limitation, a user may specify that a particular image uploaded by the user is visible to the user's friends for the next week, after which time the image may no longer be accessible to other users. In some examples, a company may post content related to a product release ahead of the official launch and specify that the content may not be visible to other users until after the product launch.

In particular examples, for particular objects or information having privacy settings specifying that they are ephemeral, the social networking system 106 may be restricted in its access, storage, or use of the objects or information. The social networking system 106 may temporarily access, store, or use these particular objects or information in order to facilitate particular actions of a user associated with the objects or information, and may subsequently delete the objects or information, as specified by the respective privacy settings. As an example, and not by way of limitation, the user 102 may transmit a message to the user 104, and the social networking system 106 may temporarily store the message in a data store until the user 104 has viewed or downloaded the message, at which point the social networking system 106 may delete the message from the data store. In some examples, continuing with the prior example, the message may be stored for a specified period of time (e.g., 2 weeks), after which point the social networking system 106 may delete the message from the data store.

In particular examples, changes to privacy settings may take effect retroactively, affecting the visibility of objects and content shared prior to the change. As an example, and not by way of limitation, the user 102 may share a first image and specify that the first image is to be public to all other users. At a later time, the user 102 and/or 104 may specify that any images shared by the user should be made visible only to a first user group. The social networking system 106 may determine that this privacy setting also applies to the first image and make the first image visible only to the first user group. In particular examples, the change in privacy settings may take effect only going forward. Continuing the example above, if the user 102 and/or 104 changes privacy settings and then shares a second image, the second image may be visible only to the first user group, but the first image may remain visible to all users. In particular examples, in response to a user action to change a privacy setting, the social networking system 106 may further prompt the user to indicate whether the user wants to apply the changes to the privacy setting retroactively. In particular examples, a user change to privacy settings may be a one-off change specific to one object. In particular examples, a user's change to privacy may be a global change for all objects associated with the user.

In particular examples, the social networking system 106 may determine that user 102 and/or 104 may want to change one or more privacy settings in response to a trigger action associated with the user 102 and/or 104. The trigger action may be any suitable action on the online social network. As an example, and not by way of limitation, a trigger action may be a change in the relationship between a first and second user of the online social network (e.g., “un-friending” a user, changing the relationship status between the users, etc.). In particular examples, upon determining that a trigger action has occurred, the social networking system 106 may prompt the user 102 and/or 104 to change the privacy settings regarding the visibility of objects associated with the user 102 and/or 104. The prompt may redirect the user 102 and/or 104 to a workflow process for editing privacy settings with respect to one or more entities associated with the trigger action. The privacy settings associated with the user 102 and/or 104 may be changed only in response to an explicit input from the user 102 and/or 104 and may not be changed without the approval of the user 102 and/or 104. As an example, and not by way of limitation, the workflow process may include providing the user 102 with the current privacy settings with respect to the user 104 or to a group of users (e.g., un-tagging the user 102 or the user 104 from particular objects, changing the visibility of particular objects with respect to the user 104 or a group of users), and receiving an indication from the user 102 to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example, and not by way of limitation, a user's default privacy settings may indicate that a person's relationship status is visible to all users (i.e., “public”). However, if the user changes his or her relationship status, the social networking system 106 may determine that such action may be sensitive and may prompt the user to confirm that his or her relationship status should remain public before proceeding. In some examples, a user's privacy settings may specify that the user's posts are visible only to friends of the user. However, if the user changes the privacy setting for his or her posts to being public, the social networking system 106 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example, and not by way of limitation, the social networking system 106 may send a reminder to the user to confirm his or her privacy settings every six months or after every ten photo posts. In particular examples, privacy settings may also allow users to control access to the objects or information on a per-request basis. As an example, and not by way of limitation, the social networking system 106 may notify the user whenever a third-party system attempts to access information associated with the user and require the user to provide verification that access should be allowed before proceeding.

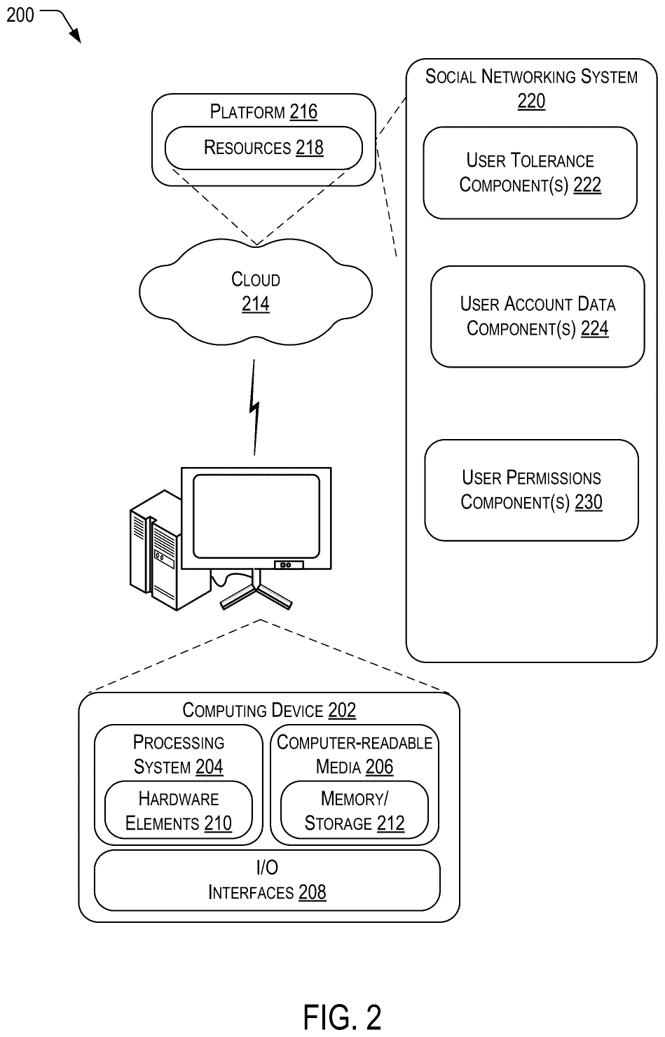

FIG. 2 illustrates an example system 200 that includes an example computing device 202 that is representative of one or more computing systems and/or devices that may implement the various techniques described herein. This is illustrated through inclusion of a social networking system 220, which may be similar to social networking system 106 of FIG. 1. The illustrated social networking system 220 comprises a user tolerance component 222, a user account data component 224, and a user permissions component 226. The user tolerance component 222, user account data component 224, and user permissions component 226 may each be similar, respectively, to the user tolerance component 116, the user account data component 118, and the user permissions component 120 of FIG. 1.

The computing device 202 may be, for example, a server of a service provider, a device associated with a client (e.g., a client device), an on-chip system, and/or any other suitable computing device or computing system. The example computing device 202 as illustrated includes a processing system 204, one or more computer-readable media 206, and one or more I/O interfaces 208 that are communicatively coupled, one to another. Although not shown, the computing device 202 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 204 is representative of functionality to perform one or more operations using hardware. Accordingly, the processing system 204 is illustrated as including hardware elements 210 that may be configured as processors, functional blocks, and so forth. This may include implementation in hardware as an application specific integrated circuit or other logic device formed using one or more semiconductors. The hardware elements 210 are not limited by the materials from which they are formed, or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 206 is illustrated as including memory/storage 212. The memory/storage 212 represents memory/storage capacity associated with one or more computer-readable media. The memory/storage 212 may include volatile media (such as random access memory (RAM)) and/or nonvolatile media (such as read only memory (ROM), Flash memory, optical disks, magnetic disks, and so forth). The memory/storage 212 may include fixed media (e.g., RAM, ROM, a fixed hard drive, and so on) as well as removable media (e.g., Flash memory, a removable hard drive, an optical disc, and so forth). The computer-readable media 206 may be configured in a variety of other ways as further described below.

Input/output interface(s) 208 are representative of functionality to allow a user to enter commands and information to computing device 202, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 202 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on and/or transmitted across some form of computer-readable media. The computer-readable media may include a variety of media that may be accessed by the computing device 202. By way of example, and not limitation, computer-readable media may include “computer-readable storage media” and “computer-readable transmission media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable transmission media” may refer to a medium that is configured to transmit instructions to the hardware of the computing device 202, such as via a network. Computer-readable transmission media typically may transmit computer-readable instructions, data structures, program modules, or other data in a modulated data signal, such as carrier waves, data signals, or other transport mechanism. Computer-readable transmission media also includes any information delivery media. The term “modulated data signal” means a signal that has one or more of its characteristics set or changed in such a manner as to encode information in the signal. By way of example, and not limitation, computer-readable transmission media include wired media such as a wired network or direct-wired connection, and wireless media such as acoustic, radio frequency (RF), infrared, and other wireless media.

As previously described, hardware elements 210 and computer-readable media 206 are representative of modules, programmable device logic and/or device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 210. The computing device 202 may be configured to implement particular instructions and/or functions corresponding to the software and/or hardware modules. Accordingly, implementation of a module that is executable by the computing device 202 as software may be achieved at least partially in hardware, e.g., through use of computer-readable storage media and/or hardware elements 210 of the processing system 204. The instructions and/or functions may be executable/operable by one or more articles of manufacture (for example, one or more computing devices 202 and/or processing systems 204) to implement techniques, modules, and examples described herein.

The techniques described herein may be supported by various configurations of the computing device 202 and are not limited to the specific examples of the techniques described herein. This functionality may also be implemented all or in part through use of a distributed system, such as over a computing environment or “cloud” 214 via a platform 216 as described below.

The cloud 214 includes and/or is representative of a platform 216 for resources 218. The platform 216 abstracts underlying functionality of hardware (e.g., servers) and software resources of the cloud 214. The resources 218 may include applications and/or data that can be utilized while computer processing is executed on servers that are remote from the computing device 202. Resources 218 can also include services provided over the Internet and/or through a subscriber network, such as a cellular or Wi-Fi network.

The platform 216 may abstract resources and functions to connect the computing device 202 with other computing devices. The platform 216 may also be scalable to provide a corresponding level of scale to encountered demand for the resources 218 that are implemented via the platform 216. Accordingly, in an interconnected device embodiment, implementation of functionality described herein may be distributed throughout multiple devices of the system 200. For example, the functionality may be implemented in part on the computing device 202 as well as via the platform 216 which may represent a cloud computing environment.

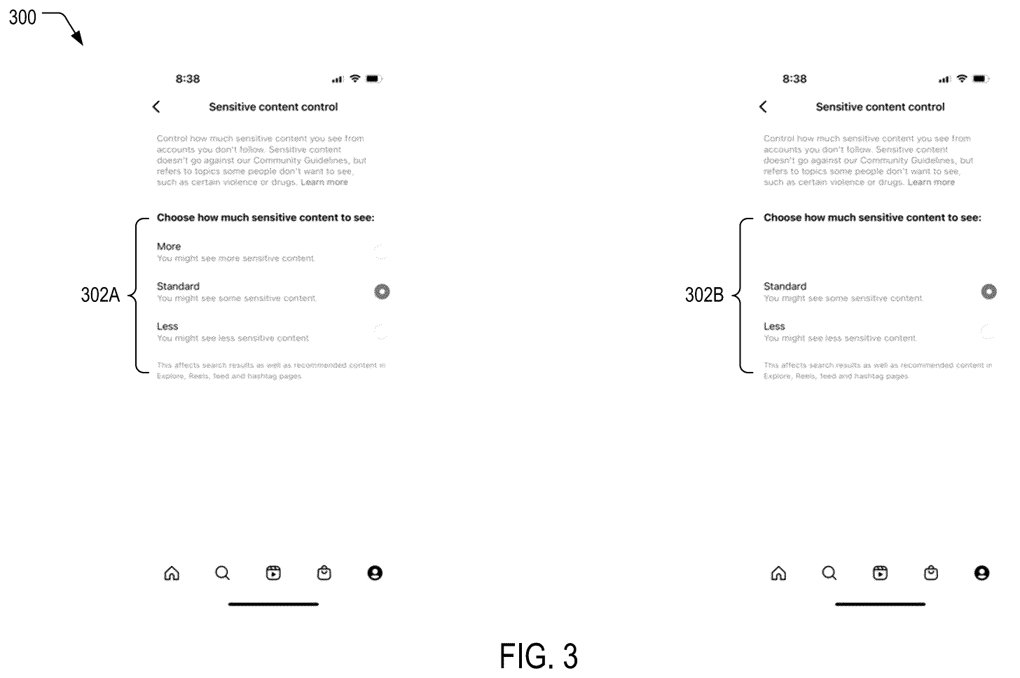

FIG. 3 is an example interface 300 illustrating various modes for setting sensitivity control settings, according to some implementations. For example, the example interface 300 may be similar to the I/O interface(s) 208 described above with regard to FIG. 2. The example interface 300 may be configured to receive input, via sensitive content controls 302A, 302B to set various sensitivity control settings. For example, in the case that the user 102 is of a first age range that satisfies an age threshold (e.g., 18 years old or above), the content controls 302A may be configured to allow the user 102 to set one of three sensitivity control modes (i.e., to show more, a standard amount, or less sensitive content). In the case that the user 102 is of a second age range below an age threshold, the content controls 302B may be configured to allow the user 102 to set one of two sensitivity control modes (i.e., to show a standard amount or less sensitive content).

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
receiving, from a device associated with a first user, a request to generate a first user account associated with a social networking system;
receiving, from the device associated with the first user, one or more instances of first user account data, wherein the one or more instances of first user account data include at least an indication of an age of the first user;
generating, based at least in part on the one or more instances of first user account data, the first user account;
determining an threshold user tolerance level associated with one or more sensitive content classifications; and
configuring, based at least in part on determining that the age of the first user fails to satisfy a sensitive content age threshold, one or more first user account settings to screen sensitive at or above the threshold user tolerance level.

2. The method of claim 1, wherein the one or more sensitive content classifications include one or more of nudity, violence, sexuality, and obscenity.

3. The method of claim 1, wherein determining the threshold user tolerance level comprises:
determining that content characterized by the one or more sensitive content classifications defines an equal probability of being deemed by one or more other users as either inappropriate or appropriate.

4. The method of claim 1, further comprising:
receiving, from the device associated with the first user, a request to change the one or more first user account settings to screen sensitive content at the threshold user tolerance level; and
presenting, to the first user, content associated with the social networking system, wherein sensitive content consists of content below the threshold user tolerance level.

5. The method of claim 1, wherein screening the sensitive content at or above the threshold user tolerance level comprises one or more of filtering the sensitive content, down ranking the sensitive content, or providing a warning prior to presenting the sensitive content.

6. The method of claim 1, wherein screening the sensitive content at or above the threshold user tolerance level comprises screening the sensitive content from presentation on one or more of explore pages, reels, searches, friend suggestions, in-feed recommendations, comments, hashtag pages, and autocomplete results.

7. The method of claim 1, wherein the sensitive content age threshold is one of 14 years old, 16 years old, 17 years old, or 18 years old.

8. A system comprising:
one or more processors; and
one or more computer-readable media storing instructions that, when executed by the one or more processors, cause the system to perform operations comprising:
receiving, from a device associated with a first user, a request to generate a first user account associated with a social networking system;
receiving, from the device associated with the first user, one or more instances of first user account data, wherein the one or more instances of first user account data include at least an indication of an age of the first user;
generating, based at least in part on the one or more instances of first user account data, the first user account;
determining an threshold user tolerance level associated with one or more sensitive content classifications; and
configuring, based at least in part on determining that the age of the first user fails to satisfy a sensitive content age threshold, one or more first user account settings to screen sensitive at or above the threshold user tolerance level.

9. The system of claim 8, wherein the one or more sensitive content classifications include one or more of nudity, violence, sexuality, and obscenity.

10. The system of claim 8, wherein determining the threshold user tolerance level comprises:
determining that content characterized by the one or more sensitive content classifications defines an equal probability of being deemed by one or more other users as either inappropriate or appropriate.

11. The system of claim 8, further comprising:
receiving, from the device associated with the first user, a request to change the one or more first user account settings to screen sensitive content at the threshold user tolerance level; and
presenting, to the first user, content associated with the social networking system, wherein sensitive content consists of content below the threshold user tolerance level.

12. The system of claim 8, wherein screening sensitive content at or above the threshold user tolerance level comprises one or more of filtering the sensitive content, down ranking the sensitive content, or providing a warning prior to presenting the sensitive content.

13. The system of claim 8, wherein screening the sensitive content at or above the threshold user tolerance level comprises screening the sensitive content from presentation on one or more of explore pages, reels, searches, friend suggestions, in-feed recommendations, comments, hashtag pages, and autocomplete results.

14. The system of claim 8, wherein the sensitive content age threshold is one of 14 years old, 16 years old, 17 years old, or 18 years old.

15. One or more non-transitory computer-readable media storing instructions that, when executed by one or more processors, cause one or more computing devices to perform operations comprising;
receiving, from a device associated with a first user, a request to generate a first user account associated with a social networking system;
receiving, from the device associated with the first user, one or more instances of first user account data, wherein the one or more instances of first user account data include at least an indication of an age of the first user;
generating, based at least in part on the one or more instances of first user account data, the first user account;
determining an threshold user tolerance level associated with one or more sensitive content classifications; and
configuring, based at least in part on determining that the age of the first user fails to satisfy a sensitive content age threshold, one or more first user account settings to screen sensitive at or above the threshold user tolerance level.

16. The one or more non-transitory computer-readable media of claim 15, wherein the one or more sensitive content classifications include one or more of nudity, violence, sexuality, and obscenity.

17. The one or more non-transitory computer-readable media of claim 15, wherein determining the threshold user tolerance level comprises:
determining that content characterized by the one or more sensitive content classifications defines an equal probability of being deemed by one or more other users as either inappropriate or appropriate.

18. The one or more non-transitory computer-readable media of claim 15, wherein sensitive content age threshold is one of 14 years old, 16 years old, 17 years old, or 18 years old; and further comprising:
receiving, from the device associated with the first user, a request to change the one or more first user account settings to screen sensitive content at the threshold user tolerance level; and
presenting, to the first user, content associated with the social networking system, wherein sensitive content consists of content below the threshold user tolerance level.

19. The one or more non-transitory computer-readable media of claim 15, wherein screening sensitive content at or above the threshold user tolerance level comprises one or more of filtering the sensitive content, down ranking the sensitive content, or providing a warning prior to presenting the sensitive content.

20. The one or more non-transitory computer-readable media of claim 15, wherein screening the sensitive content at or above the threshold user tolerance level comprises screening the sensitive content from presentation on one or more of explore pages, reels, searches, friend suggestions, in-feed recommendations, comments, hashtag pages, and autocomplete results.
